(19) United States
(12) Patent Application Publication
(10) Pub. No.: US 2026/0354955 A1
(43) Pub. Date: Nov. 12, 2026

(54) SYSTEM AND A METHOD FOR CONTROLLED DELIVERY OF ROOT CANAL IRRIGATION SOLUTION

(71) Applicants: MOHAMMED MUSTAFA, AL-KHARJ (SA); KAVALIPURAPU VENKATA TEJA, HYDERABAD (IN); AHMED ABDULAZIZ S ALMOKHATIEB, RIYADH (SA); ABDULAZIZ ABDULWAHED, RIYADH (SA); LAILA SAAD BIN ABDULAZIZ ALMUFLEH, RIYADH (SA); QAMAR MOHAMMADZIAD HASHEM, RIYADH (SA); OSAMAH FAHAD ALQASEM, RIYADH (SA); SHAHAD SAUD ALBADER, RIYADH (SA); ABDULLAH MOHAMMED ALSHEHRI, RIYADH (SA); ALI ROBAIAN ALQAHTANI, RIYADH (SA); NASSER RAQE ALQHTANI, RIYADH (SA); ABDULLAH SAAD ALQAHTANI, RIYADH (SA)

(72) Inventors: MOHAMMED MUSTAFA, AL-KHARJ (SA); KAVALIPURAPU VENKATA TEJA, HYDERABAD (IN); AHMED ABDULAZIZ S ALMOKHATIEB, RIYADH (SA); ABDULAZIZ ABDULWAHED, RIYADH (SA); LAILA SAAD BIN ABDULAZIZ ALMUFLEH, RIYADH (SA); QAMAR MOHAMMADZIAD HASHEM, RIYADH (SA); OSAMAH FAHAD ALQASEM, RIYADH (SA); SHAHAD SAUD ALBADER, RIYADH (SA); ABDULLAH MOHAMMED ALSHEHRI, RIYADH (SA); ALI ROBAIAN ALQAHTANI, RIYADH (SA); NASSER RAQE ALQHTANI, RIYADH (SA); ABDULLAH SAAD ALQAHTANI, RIYADH (SA)

(21) Appl. No.: 19/667,731

(22) Filed: May 5, 2026

(30) Foreign Application Priority Data
May 6, 2025 (IN) 202541044045

(51) Int. Cl. A61C 17/028; A61C 5/40

(52) U.S. Cl. CPC A61C 17/028; A61C 5/40

(57) ABSTRACT

A system 100 for controlled delivery of root canal irrigation solution is provided. The system includes an endodontic irrigation management unit 105 includes at least one endodontic irrigation solution container 110 to store the root canal irrigation solution in a controlled environment and a metal plunger 115 generates positive pressure to transfer the solution based on a plurality of predetermined parameters. Using a user interface unit 120 sets the plurality of predetermined parameters, real-time monitoring is achieved through a pressure sensor and a display unit 125 that shows real-time data. A control unit ensures safety by halting solution delivery if pressure exceeds the pre-set threshold. A hand-held unit 135 with a stainless-steel hollow core 140 ensures easy maintenance and incorporates a modified attachment 145 for delivering the solution to designated areas at predetermined levels.

### EARLIEST PRIORITY DATE

This Application claims priority from a complete patent application filed in India having Patent Application No. 202541044045, filed on 6 May 2025, and titled “A SYSTEM AND A METHOD FOR CONTROLLED DELIVERY OF ROOT CANAL IRRIGATION SOLUTION”.

### FIELD OF INVENTION

Embodiments of the present disclosure relate to the field of dental treatment, and more particularly, a system and a method for controlled delivery of root canal irrigation solution.

### BACKGROUND

Root canal irrigation delivery is a process of injecting a cleaning solution or root canal irrigation solution into root canal of a tooth during a root canal procedure, typically using a syringe and needle to flush out debris and bacteria from the root canal, aiming to thoroughly disinfect the area and prepare it for filling, this is a crucial step in root canal procedure.

Conventionally, root canal irrigation is performed using commercially available syringes with different volumes and gauges. An operator must apply manual pressure for delivery of the cleaning solution into the root canal space.

The complete disinfection of the root canal procedure is typically achieved using a common irrigating solution such as 5.25% Sodium hypochlorite. But the major disadvantage of the routine delivery of the root canal irrigating solution is that the manual pressure must be applied to the syringe externally by the operator for the root canal irrigating solution to flow out of the needle. Over time, the manual process may cause operator fatigue, leading to an inability to maintain consistent pressure, and consequently, an uneven flow rate or volume of irrigation solution delivered.

Hence, there is a need for an improved system and a method for controlled delivery of root canal irrigation solution which addresses the aforementioned issue(s).

### OBJECTIVES OF THE INVENTION

The primary objective of the invention is to develop a system for controlled delivery of root canal irrigation solution based on predetermined parameters set by an operator.

The primary objective of the invention is to automatically halt the delivery of medicine or irrigation solution when the pressure exceeds a pre-set threshold during the root canal irrigation.

Another objective of the invention is to introduce a hand-held unit with a stainless-steel hollow core, which is designed for easy insertion of a transparent connecting tube. The stainless-steel hollow core is divided into two parts, connected by a screw cap or twist mechanism, offering secure attachment and ease of use.

Another objective of the invention is to incorporate a modified attachment that securely connects to a 30-gauge side-vented needle to deliver irrigation solutions with improved accuracy and control.

### BRIEF DESCRIPTION

In accordance with an embodiment of the present disclosure, a system for controlled delivery of root canal irrigation solution is provided. The system includes an endodontic irrigation management unit, including at least one endodontic irrigation solution container affixed in the endodontic irrigation management unit. The at least one endodontic irrigation solution container is adapted to store the root canal irrigation solution in a controlled environment. The endodontic irrigation solution container is prefilled with the root canal irrigation solution. The endodontic irrigation management unit includes a metal plunger connected to the at least one endodontic irrigation solution container. The metal plunger is adapted to generate a positive pressure to facilitate the transfer of the root canal irrigation solution through a dose dispensing mechanism from the at least one endodontic irrigation solution container based on a predetermined parameters pertaining to root canal irrigation solution. The endodontic irrigation management unit includes a user interface unit adapted to enable an operator to set the plurality of predetermined parameters. The endodontic irrigation management unit includes at least one pressure sensor unit operatively coupled to the user interface unit. The at least one pressure sensor unit is adapted to detect the pressure generated in the root canal in real time during irrigation as part of an endodontic treatment of a patient. The endodontic irrigation management unit includes a control unit operatively coupled to the metal plunger and the at least one pressure sensor unit. The control unit is adapted to halt the delivery of the root canal irrigation solution if the pressure value during the root canal irrigation exceeds a pre-set threshold pressure value set by the operator. The endodontic irrigation management unit includes a display unit operatively coupled to the control unit. The display unit is adapted to display the real-time data of the plurality of predetermined parameters of the root canal irrigation solution during the root canal procedure. The system includes at least one connecting tube connected to the at least one endodontic irrigation solution container. The at least one connecting tube is adapted to allow the root canal irrigation solution to flow from the at least one endodontic irrigation solution container. The system includes a hand-held unit operatively connected to the at least one connecting tube. The hand-held unit includes a stainless-steel hollow core adapted to accommodate the at-least one connecting tube. The hollow core is divided into a first part and a second part joined by a screw cap mechanism for easy assembly, removal, and reattachment of the at least one connecting tube. The hand-held unit includes a modified attachment located at a distal end of the at least one connecting tube. The modified attachment is adapted to accommodate at least one commercially available root canal irrigation needle. The at least one commercially available root canal irrigation needle is adapted to deliver the root canal irrigation solution to a designated tooth at controlled, predetermined levels for a specified duration during the root canal procedure.

In accordance with another embodiment of the present disclosure, a method for controlled delivery of root canal irrigation solution is provided. The method includes storing, by at least one endodontic irrigation solution container affixed in an endodontic irrigation management unit, the root canal irrigation solution in a controlled environment. The endodontic irrigation solution container is prefilled with the root canal irrigation solution. The method includes generating, by a metal plunger, a positive pressure to facilitate the transfer of the root canal irrigation solution through a dose dispensing mechanism from the at least one endodontic irrigation solution container based on a predetermined parameters pertaining to root canal irrigation solution. The method includes enabling, by a user interface unit, an operator to set the plurality of predetermined parameters. The method includes detecting, by at least one pressure sensor unit, the pressure generated in the root canal in real time during irrigation as part of an endodontic treatment of a patient. The method includes halting, by a control unit, the delivery of the root canal irrigation solution if the pressure value during the root canal irrigation exceeds a pre-set threshold pressure value set by the operator. The method includes displaying, by a display unit, the real-time data of the plurality of predetermined parameters of the root canal irrigation solution during the root canal procedure. The method includes allowing, by at least one connecting tube, the root canal irrigation solution to flow from the at least one endodontic irrigation solution container. The method includes accommodating, by a stainless-steel hollow core of a hand-held unit, the at-least one connecting tube. The hollow core is divided into a first part and a second part joined by a screw cap mechanism for easy assembly, removal, and reattachment of the at least one connecting tube. The method includes accommodating, a modified attachment of the hand-held unit, at least one commercially available root canal irrigation needle. The at least one commercially available root canal irrigation needle is adapted to deliver the root canal irrigation solution to a designated tooth at controlled, predetermined levels for a specified duration during the root canal procedure.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a system for controlled delivery of root canal irrigation solution in accordance with an embodiment of the present disclosure;

FIG. 2 is a schematic representation of an exploded view of a hand-held unit of FIG. 1, in accordance with an embodiment of the present disclosure;

FIG. 3 is a schematic representation of attachment of a commercially available root canal irrigation needle to a modified attachment of a hand-held unit, which operates as a dose dispensing mechanism, in accordance with an embodiment of the present disclosure;

FIG. 4(a) illustrates a flow chart representing the steps involved in a method for controlled delivery of root canal irrigation solution in accordance with an embodiment of the present disclosure; and

FIG. 4(b) illustrates continued steps of the method of FIG. 4(a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for controlled delivery of root canal irrigation solution. The system includes an endodontic irrigation management unit, including at least one endodontic irrigation solution container affixed in the endodontic irrigation management unit. The at least one endodontic irrigation solution container is adapted to store the root canal irrigation solution in a controlled environment. The endodontic irrigation solution container is prefilled with the root canal irrigation solution. The endodontic irrigation management unit includes a metal plunger connected to the at least one endodontic irrigation solution container. The metal plunger is adapted to generate a positive pressure to facilitate the transfer of the root canal irrigation solution through a dose dispensing mechanism from the at least one endodontic irrigation solution container based on a predetermined parameters pertaining to root canal irrigation solution. The endodontic irrigation management unit includes a user interface unit adapted to enable an operator to set the plurality of predetermined parameters. The endodontic irrigation management unit includes at least one pressure sensor unit operatively coupled to the user interface unit. The at least one pressure sensor unit is adapted to detect the pressure generated in the root canal in real time during irrigation as part of an endodontic treatment of a patient. The endodontic irrigation management unit includes a control unit operatively coupled to the metal plunger and the at least one pressure sensor unit. The control unit is adapted to halt the delivery of the root canal irrigation solution if the pressure value during the root canal irrigation exceeds a pre-set threshold pressure value set by the operator. The endodontic irrigation management unit includes a display unit operatively coupled to the control unit. The display unit is adapted to display the real-time data of the plurality of predetermined parameters of the root canal irrigation solution during the root canal procedure. The system includes at least one connecting tube connected to the at least one endodontic irrigation solution container. The at least one connecting tube is adapted to allow the root canal irrigation solution to flow from the at least one endodontic irrigation solution container. The system includes a hand-held unit operatively connected to the at least one connecting tube. The hand-held unit includes a stainless-steel hollow core adapted to accommodate the at-least one connecting tube. The hollow core is divided into a first part and a second part joined by a screw cap mechanism for easy assembly, removal, and reattachment of the at least one connecting tube. The hand-held unit includes a modified attachment located at a distal end of the at least one connecting tube. The modified attachment is adapted to accommodate at least one commercially available root canal irrigation needle. The at least one commercially available root canal irrigation needle is adapted to deliver the root canal irrigation solution to a designated tooth at controlled, predetermined levels for a specified duration during the root canal procedure.

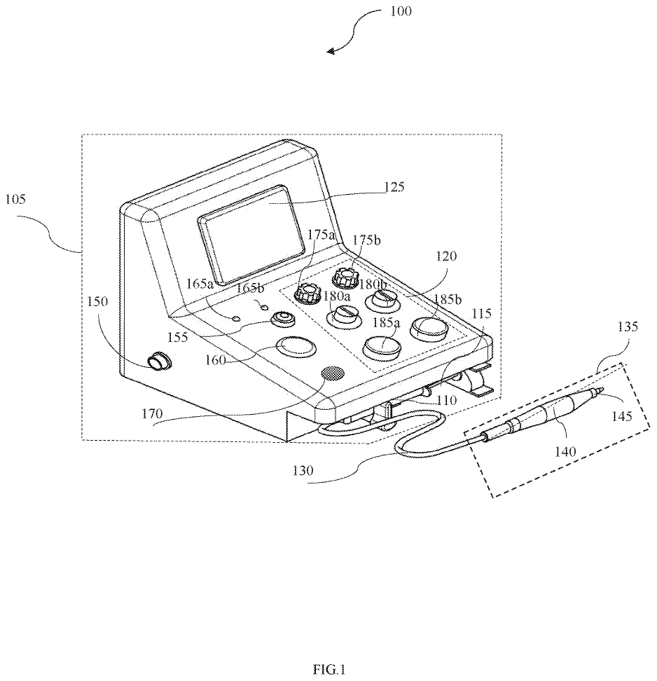

FIG. 1 is a schematic representation of a system 100 for controlled delivery of root canal irrigation solution in accordance with an embodiment of the present disclosure. The system 100 includes an endodontic irrigation management unit 105, including at least one endodontic irrigation solution container 110 affixed in the endodontic irrigation management unit 105. The at least one endodontic irrigation solution container 110 is adapted to store the root canal irrigation solution in a controlled environment for a root canal procedure. The at least one endodontic irrigation solution container 110 is prefilled with the root canal irrigation solution, thereby eliminating the need for manual refilling during the root canal procedure and minimizing the risk of contamination between steps of the root canal procedure. The controlled environment refers to an environment that maintains the root canal irrigation solution in optimal conditions including sterility, protection from external contamination, maintenance of an appropriate temperature and the like.

In one embodiment, the at least one endodontic irrigation solution container 110 is adapted to accommodate a volume of root canal irrigation solution in the range of approximately 20 to 30 milliliters. However, the dimensions of the at least one endodontic irrigation solution container 110 may vary based on the requirements of the root canal irrigation solution for a specific procedure, as well as industrial requirements and is not limited to this range. The materials used to fabricate the at least one endodontic irrigation solution container 110 may include, but are not limited to, glass, plastic, high-density polyethylene, polypropylene, and the like.

The endodontic irrigation management unit 105 includes a metal plunger 115 connected to the at least one endodontic irrigation solution container 110. The metal plunger 115 is adapted to generate a positive pressure to facilitate the transfer of the root canal irrigation solution through a dose dispensing mechanism from the at least one endodontic irrigation solution container 110 based on a plurality of predetermined parameters pertaining to root canal irrigation solution. The positive pressure generated is regulated according to the predetermined parameters set by an operator. The plurality of predetermined parameters includes but are not limited to a flow rate, a pre-set pressure threshold, predetermined duration, a volume limit, and the like. The flow rate refers to speed at which the root canal irrigation solution is delivered from the at least one endodontic irrigation solution container to the root canal, typically measured in milliliters per minute. The pre-set pressure threshold value measures a maximum allowable pressure during the delivery of the root canal irrigation solution. The predetermined duration is time interval the irrigation solution is delivered to the root canal. The volume limit is the maximum volume of irrigation solution that can be delivered during the root canal procedure.

In one embodiment, the metal plunger 115 generates positive pressure to induce irrigant flow at a rate ranging from 0.5 ml/min to 15 ml/min.

The dose dispensing mechanism refers to a setup configured to accurately measure and release the root canal irrigation solution based on a plurality of predetermined parameters and a specified amount.

In another embodiment, the at least one endodontic irrigation solution container 110 and the metal plunger 115 may be implemented as the dose dispensing mechanism. In the dose dispensing mechanism, an endodontic irrigation container serves as the at least one endodontic irrigation solution container 110, holding the root canal irrigation solution, while the metal plunger inherent in the embodiment generates the positive pressures for the root canal irrigant delivery.

Although referred to as the metal plunger 115, in certain embodiments, the plunger may be fabricated from other suitable materials, including but not limited to plastic, polymer-based materials, and the like. The choice of material may vary depending on cost, structural requirements, and the industrial requirements.

The endodontic irrigation management unit 105 includes a user interface unit 120 adapted to enable an operator to set the plurality of predetermined parameters. The user interface unit 120 includes a flow rate increase button 175a and a flow rate decrease button 175b. The user interface unit 120 includes a volume increase button 180a and a volume decrease button 180b. The user interface unit 120 includes a program up-selection button 185a and a program down-selection button 185b. Specifically, the flow rate increase button 175a and the flow rate decrease button 175b, adapted to increase and decrease the flow rate of the endodontic irrigation solution, respectively. The volume increase button 180a and the volume decrease button 180b, adapted to regulate the total volume of irrigation solution delivered during the procedure. Additionally, the program up-selection button 185 and the program down-selection button 185b, adapted to navigate and select among a plurality of preset programs for automatic adjustment of flow rate and volume based on the type of tooth and anatomical site being treated.

In an embodiment, the user interface unit 120 may include but not be limited to a plurality of input mechanisms, such as a plurality of control buttons, a touch screen, a number pad, and the like, allowing the operator to adjust values of the predetermined parameters.

In one embodiment, the plurality of control buttons may include a knob, which may be used to increase or decrease the values of the predetermined parameters depending on the requirements of the root canal procedure.

The endodontic irrigation management unit 105 includes at least one pressure sensor unit 170 operatively coupled to the user interface unit 120. The at least one pressure sensor unit 170 is adapted to detect the pressure generated in the root canal in real time during irrigation as part of an endodontic treatment of a patient. Examples for the at least one pressure sensor unit 170 include but are not limited to piezoelectric pressure sensors, capacitive pressure sensors, strain gauge pressure sensors, and the like.

The endodontic irrigation management unit 105 includes a control unit (not shown in FIG. 1) operatively coupled to the metal plunger 115 and the at least one pressure sensor unit 170. The control unit not shown in FIG. 1 is adapted to halt the delivery of the root canal irrigation solution if the pressure value during the root canal irrigation exceeds a pre-set threshold pressure value set by the operator. As the metal plunger pushes the irrigant in the endodontic irrigation container and creates the positive pressure, and the metal plunger 115 delivers the root canal irrigation solution through the dose dispensing mechanism. The control unit (not shown in FIG. 1) continuously compares the real-time pressure value from the at least one pressure sensor unit 170 to the pre-set threshold value. If the measured pressure exceeds the pre-set threshold, indicating over-pressurization, the control unit (not shown in FIG. 1) automatically halts the delivery of the root canal irrigation solution by deactivating the metal plunger 115.

It must be noted that the control unit (not shown in FIG. 1) manages and coordinates the entire process, communicating with all units including the metal plunger 115 and the at least one pressure sensor unit 170. Overall, the control unit (not shown in FIG. 1) within the system 100 exemplifies advanced automation and integration, orchestrating the synchronized operation of critical units to achieve comprehensive objectives for controlled delivery of root canal irrigation solution.

The endodontic irrigation management unit 105 includes a display unit 125 operatively coupled to the control unit (not shown in FIG. 1). The display unit 125 is adapted to display real-time data of the plurality of predetermined parameters of the root canal irrigation solution during the root canal procedure. The real-time data may include, but is not limited to, the current flow rate of the irrigation solution, the pressure generated during irrigation, the total volume delivered, the remaining solution in the container, and the like.

In one embodiment, the display unit 125 may visually represent the real-time data in graphical formats.

The system 100 includes at least one connecting tube 130 connected to the at least one endodontic irrigation solution container 110. The at least one connecting tube 130 is adapted to allow the root canal irrigation solution to flow from the at least one endodontic irrigation solution container 110. The at least connecting tube is a flexible, transparent cylindrical tube made of PVC material, allowing the operator to visually monitor the solution flow.

The system 100 includes a hand-held unit 135 operatively connected to the at least one connecting tube 130. The hand-held unit 135 includes a stainless-steel hollow core 140 adapted to accommodate the at-least one connecting tube. The hollow core 140 is divided into a first part and a second part joined by a screw cap mechanism for easy assembly, removal, and reattachment of the at least one connecting tube 130.

Once the root canal irrigation is complete, the at least one connecting tube 130 may be replaced by twisting a screw cap, inserting a new tube, and re-tightening the screw cap. The screw cap mechanism simplifies maintenance and ensures the system 100 is ready for subsequent use.

The hand-held unit 135 includes a modified attachment 145 located at a distal end of the at least one connecting tube 130. The modified attachment 145 is a stiff plastic polymer tip. The modified attachment 145 is adapted to accommodate at least one commercially available root canal irrigation needle. The at least one commercially available root canal irrigation needle is adapted to deliver the root canal irrigation solution to a designated tooth at controlled, predetermined levels for a specified duration during the root canal procedure. In one embodiment, the system 100 uses a 30-gauge side-vented needle for precise delivery.

The system 100 includes a power supply unit to power the endodontic irrigation management unit 105. The power supply unit includes a rechargeable battery and a charging port 150 compatible with a standard 3-pin plug. The maximum solution delivery rate achievable by the system 100 is approximately 10-15 milliliters per minute.

The endodontic irrigation management unit 105 includes an auto-set button 155, a power-on button 160, and a pair of visual indicators 165a, 165b. A first visual indicator 165a represents the endodontic irrigation management unit 105's battery charge status, changing color based on the remaining power level. A second visual indicator 165b represents the presence of an active AC power connection, confirming when the endodontic irrigation management unit 105 is connected to an external power source for operation or charging.

Let's consider an example, a user “X” a dentist, is performing a root canal procedure on a patient. For that, the user “X” uses the system for controlled delivery of the root canal irrigation solution and sets the predetermined parameters via the user interface unit that includes the flow rate to 5 milliliters, pre-set pressure threshold to 15 psi. As the procedure begins, the metal plunger generates a positive pressure to transfer the root canal irrigation solution from the at least one endodontic irrigation solution container to the root canal through a root canal irrigation needle attached on the hand-held unit. During the delivery the pressure sensor detects the pressure generated during root canal irrigation, and the display unit displays real-time data during the procedure.

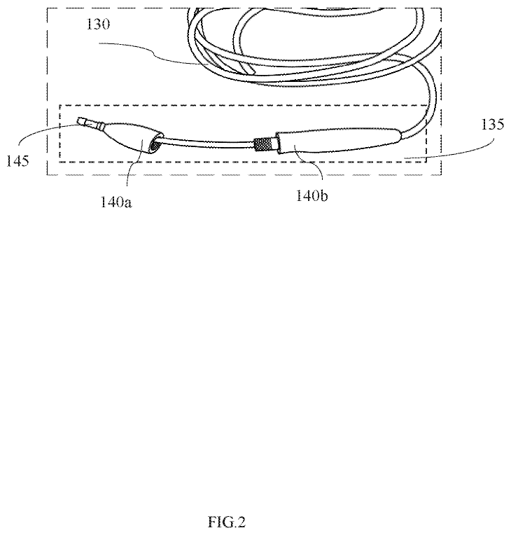

FIG. 2 is a schematic representation of an exploded view of a hand-held unit 135 of FIG. 1, in accordance with an embodiment of the present disclosure. The system 100 includes a hand-held unit 135 connected to the at least one connecting tube 130. The hand-held unit 135 includes a stainless-steel hollow core 140 adapted to accommodate the at-least one connecting tube. The hollow core 140 is divided into a first part 140a and a second part 140b joined by a screw cap mechanism for easy assembly, removal, and reattachment of the at least one connecting tube 130. At a distal end of the at least one connecting tube 130, the hand-held unit 135 is equipped with a modified attachment 145 which is a stiff plastic polymer tip to accommodate at least one commercially available root canal irrigation needle.

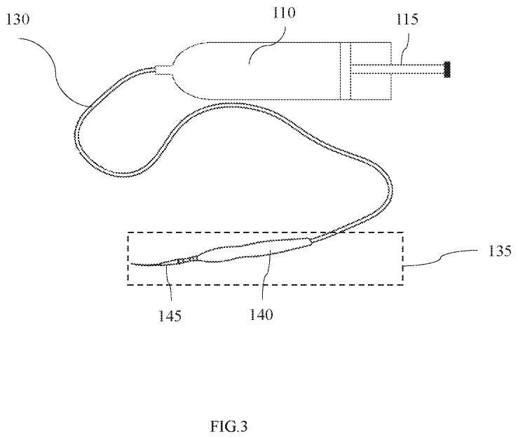

FIG. 3 is a schematic representation of attachment of a commercially available root canal irrigation needle 150 to a modified attachment of a hand-held unit, which operates as a dose dispensing mechanism, in accordance with an embodiment of the present disclosure. At least one endodontic irrigation solution container 110 and the metal plunger 115 are implemented as the dose dispensing mechanism. The at least one endodontic irrigation solution container 110, storing the root canal irrigation solution, while a metal plunger 115 operates at a positive pressure. The at least one endodontic irrigation solution container 110 is connected to the hand-held unit 135 via at least one connecting tube 130. The metal plunger generates positive pressure to transfer the irrigation solution from the endodontic irrigation solution container 110 to the hand-held unit 135. A distal end of the connecting tube 130 includes a modified attachment 145, made of a stiff plastic polymer, designed to accommodate the commercially available root canal irrigation needle 150, through which deliver the root canal irrigation solution.

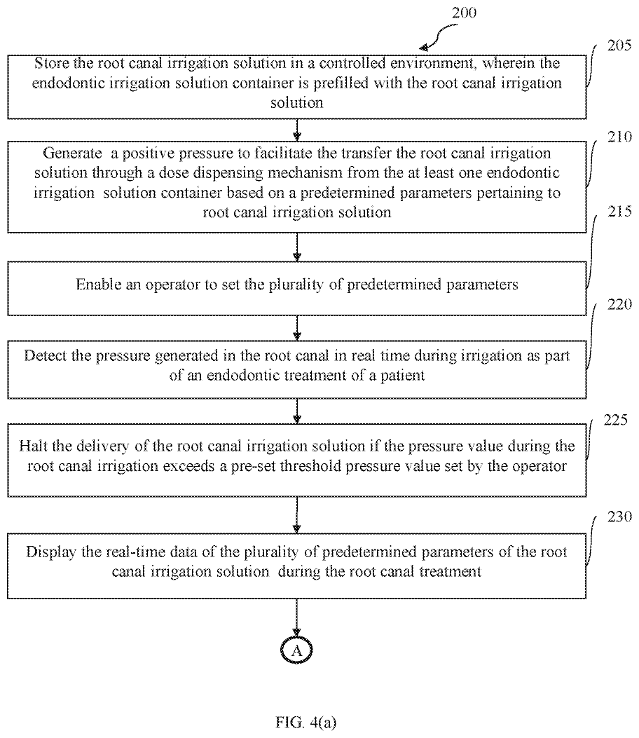

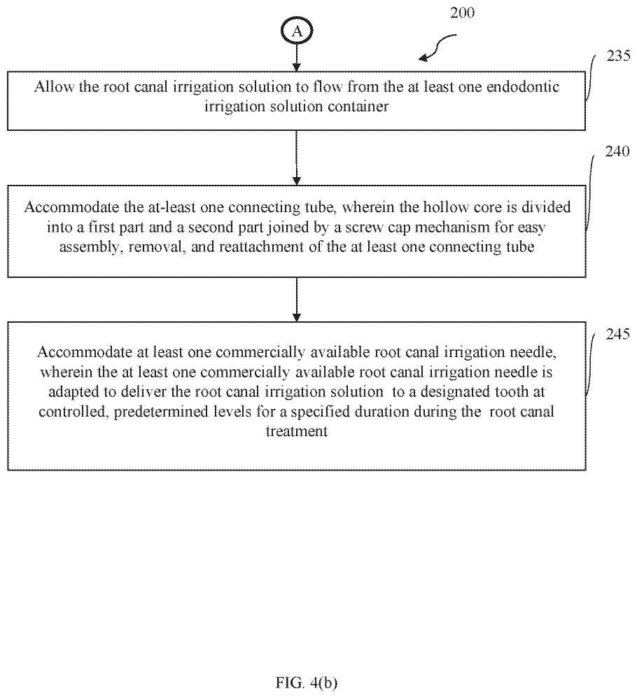

FIG. 4(a) illustrates a flow chart representing the steps involved in a method 200 for controlled delivery of root canal irrigation solution in accordance with an embodiment of the present disclosure. FIG. 4(b) illustrates continued steps of the method 200 of FIG. 4(a) in accordance with an embodiment of the present disclosure. The method 200 includes storing, by at least one endodontic irrigation solution container affixed in an endodontic irrigation management unit, the root canal irrigation solution in a controlled environment. The endodontic irrigation solution container is prefilled with the root canal irrigation solution in step 205. The prefilling eliminating the need for manual refilling during the root canal procedure and minimizing the risk of contamination between steps of the root canal procedure. The controlled environment refers to an environment that maintains the root canal irrigation solution in optimal conditions including sterility, protection from external contamination, maintenance of an appropriate temperature and the like.

The method 200 includes generating, by a metal plunger, a positive pressure to facilitate the transfer of the root canal irrigation solution through a dose dispensing mechanism from the at least one endodontic irrigation solution container based on a predetermined parameters pertaining to root canal irrigation solution in step 210. The positive pressure is regulated according to the predetermined parameters set by an operator. The predetermined parameters include but are not limited to a flow rate, a pre-set pressure threshold, predetermined duration, a volume limit, and the like.

In one embodiment, the metal plunger generates positive pressure to induce irrigant flow at a rate ranging from 0.5 ml/min to 15 ml/min.

The dose dispensing mechanism refers to a setup configured to accurately measure and release the root canal irrigation solution based on a plurality of predetermined parameters and a specified amount.

The method 200 includes enabling, by a user interface unit, an operator to set the plurality of predetermined parameters in step 215. The user interface unit may include but not limited to a plurality of input mechanisms, such as a plurality of control buttons, a touch screen, a number pad, and the like, allowing the operator to adjust values of the predetermined parameters.

In one embodiment, the plurality of control buttons may include a knob, which may be used to increase or decrease the values of the predetermined parameters depending on the requirements of the root canal procedure.

The method 200 includes detecting, by at least one pressure sensor unit, the pressure generated in the root canal in real time during irrigation as part of the endodontic treatment of a patient in step 220. Examples for the at least one pressure sensor unit include but are not limited to piezoelectric pressure sensors, capacitive pressure sensors, strain gauge pressure sensors, and the like.

The method 200 includes halting, by a control unit, the delivery of the root canal irrigation solution if the pressure value during the root canal irrigation exceeds a pre-set threshold pressure value set by the operator in step 225. As the metal plunger pushes the irrigant in the endodontic irrigation container and creates the positive pressure, and the metal plunger 115 delivers the root canal irrigation solution through the dose dispensing mechanism. The control unit continuously compares the real-time pressure value from the at least one pressure sensor unit to the pre-set threshold value. If the measured pressure exceeds the pre-set threshold, indicating over-pressurization, the control unit automatically halts the delivery of the root canal irrigation solution by deactivating the metal plunger.

The method 200 includes displaying, by a display unit, the real-time data of the plurality of predetermined parameters of the root canal irrigation solution during the root canal procedure in step 230. The real-time data may include, but is not limited to, the current flow rate of the irrigation solution, the pressure generated during irrigation, the total volume delivered, the remaining solution in the container, and the like.

The method 200 includes allowing, by at least one connecting tube, the root canal irrigation solution to flow from the at least one endodontic irrigation solution container in step 235. The at least connecting tube is a flexible, transparent cylindrical tube made of PVC material, allowing the operator to visually monitor the solution flow.

The method 200 includes accommodating, by a stainless-steel hollow core of a hand-held unit, the at-least one connecting tube. The hollow core is divided into a first part and a second part joined by a screw cap mechanism for easy assembly, removal, and reattachment of the at least one connecting tube in step 240. Once the root canal irrigation is complete, the at least one connecting tube may be replaced by twisting a screw cap, inserting a new tube, and re-tightening the screw cap. The screw cap mechanism simplifies maintenance and ensures the system is ready for subsequent use.

The method 200 includes accommodating, a modified attachment of the hand-held unit, at least one commercially available root canal irrigation needle. The at least one commercially available root canal irrigation needle is adapted to deliver the root canal irrigation solution to a designated tooth at controlled, predetermined levels for a specified duration during the root canal procedure in step 245. In one embodiment, the system uses a 30-gauge side-vented needle for precise delivery.

Various embodiments of the system and method for controlled delivery of root canal irrigation solution as described above provide several advantages. The system ensures precision delivery by accurately controlling the flow and volume of the root canal irrigation solution, optimizing delivery to the root canal procedure. Further, the system enhances cleaning by effectively flushing debris and biofilm, leading to improved treatment outcomes. The system is time-efficient, eliminating the need for manual irrigation techniques. The system has an user-friendly interface that allows operators to operate it smoothly and efficiently. Additionally, the system offers versatility by being compatible with a range of irrigation solutions, such as sodium hypochlorite, EDTA, and the like, catering to diverse clinical needs.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for controlled delivery of root canal irrigation solution comprising:
an endodontic irrigation management unit, comprising:
at least one endodontic irrigation solution container affixed in the endodontic irrigation management unit, adapted to store the root canal irrigation solution in a controlled environment, wherein the at least one endodontic irrigation solution container is prefilled with the root canal irrigation solution;
a metal plunger connected to the at least one endodontic irrigation solution container, wherein the metal plunger is adapted to generate a positive pressure to facilitate the transfer of the root canal irrigation solution through a dose dispensing mechanism from the at least one endodontic irrigation solution container based on a predetermined parameters pertaining to root canal irrigation solution;
a user interface unit adapted to enable an operator to set the plurality of predetermined parameters;
at least one pressure sensor unit operatively coupled to the user interface unit, wherein at least one pressure sensor unit is adapted to detect the pressure generated in the root canal in real time during irrigation as part of an endodontic treatment of a patient;
a control unit operatively coupled to the metal plunger and the at least one pressure sensor unit, wherein the control unit is adapted to halt the delivery of the root canal irrigation solution if the pressure value during the root canal irrigation exceeds a pre-set threshold pressure value set by the operator;
a display unit operatively coupled to the control unit, wherein the display unit is adapted to display the real-time data of the plurality of predetermined parameters of the root canal irrigation solution during the root canal procedure;
at least one connecting tube connected to the at least one endodontic irrigation solution container, wherein the at least one connecting tube is adapted to allow the root canal irrigation solution to flow from the at least one endodontic irrigation solution container; and
a hand-held unit operatively connected to the at least one connecting tube, wherein the hand-held unit comprises:
a stainless-steel hollow core adapted to accommodate the at-least one connecting tube, wherein the hollow core is divided into a first part and a second part joined by a screw cap mechanism for easy assembly, removal, and reattachment of the at least one connecting tube; and
a modified attachment located at a distal end of the at least one connecting tube, wherein the modified attachment is adapted to accommodate at least one commercially available root canal irrigation needle, wherein the at least one commercially available root canal irrigation needle is adapted to deliver the irrigation solution to a designated tooth at controlled, predetermined levels for a specified duration during the root canal procedure.

2. The system as claimed in claim 1, wherein the plurality of predetermined parameters includes a flow rate, a pre-set pressure threshold, predetermined duration, and a volume limit.

3. The system as claimed in claim 1, wherein the metal plunger generates the positive pressure to induce an irrigant flow at a rate ranging from 0.5 ml/min to 15 ml/min.

4. The system as claimed in claim 1, comprises a power supply unit, adapted to provide electrical power to the endodontic irrigation management unit, wherein the power supply unit comprises a rechargeable battery and a charging port.

5. The system as claimed in claim 1, wherein the endodontic irrigation management unit comprising an auto-set button, a power-on button, and a visual indicator.

6. The system as claimed in claim 1, wherein the user interface unit comprises:
a flow rate increase button and a flow rate decrease button;
a volume increase button and a volume decrease button; and
a program up-selection button and a program down-selection button.

7. The system as claimed in claim 1, wherein the modified attachment is a stiff plastic polymer tip.

8. The system as claimed in claim 1, wherein the root canal irrigation needle comprises a 30-gauge side-vented needle.

9. The system as claimed in claim 1, wherein the at least connecting tube is made of a transparent material to allow visual monitoring of the irrigation solution flow.

10. A method for controlled delivery of root canal irrigation solution comprising:
storing, by at least one endodontic irrigation solution container affixed in the endodontic irrigation management unit, the root canal irrigation solution in a controlled environment, wherein the endodontic irrigation solution container is prefilled with the root canal irrigation solution;
generating, by a metal plunger, a positive pressure to facilitate the transfer of the root canal irrigation solution through a dose dispensing mechanism from the at least one endodontic irrigation solution container based on a predetermined parameters pertaining to root canal irrigation solution;
enabling, by a user interface unit, an operator to set the plurality of predetermined parameters;
detecting, by at least one pressure sensor unit, the pressure generated in the root canal in real time during irrigation as part of the endodontic treatment of a patient;
halting, by a control unit, the delivery of the root canal irrigation solution if the pressure value during the root canal irrigation exceeds a pre-set threshold pressure value set by the operator;
displaying, by a display unit, the real-time data of the plurality of predetermined parameters of the root canal irrigation solution during the root canal procedure;
allowing, by at least one connecting tube, the root canal irrigation solution to flow from the at least one endodontic irrigation solution container;
accommodating, by a stainless-steel hollow core of a hand-held unit, the at-least one connecting tube, wherein the hollow core is divided into a first part and a second part joined by a screw cap mechanism for easy assembly, removal, and reattachment of the at least one connecting tube; and
accommodating, by a modified attachment, at least one commercially available root canal irrigation needle, wherein the at least one commercially available root canal irrigation needle is adapted to deliver the irrigation solution to a designated tooth at controlled, predetermined levels for a specified duration during the root canal procedure.
